(19) United States
(12) Patent Application Publication
(10) Pub. No.: US 2011/0078161 A1
(43) Pub. Date: Mar. 31, 2011

(54) SYSTEM AND METHOD FOR SHARING AND DISPLAY OF FAVORITES AMONG MULTIPLE USERS

(75) Inventors: Dang Tran, Laguna Niguel, CA (US); Andrew Shelansky, Irvine, CA (US); Esther Zheng, Irvine, CA (US); Michael Lovelace, Irvine, CA (US)

(73) Assignee: Samsung Electronics Co., Ltd., Suwon City (KR)

(21) Appl. No.: 12/571,166

(22) Filed: Sep. 30, 2009

(51) Int. Cl. G06F 17/30

(52) U.S. Cl. 707/752; 707/E17.104

(57) ABSTRACT

A system and method for sharing and displaying lists among multiple users is disclosed. In one embodiment, the method comprises receiving a first list of items from a first user device, generating a sorted list based on at least the first list and a second list, and displaying the sorted list. Multiple lists of items can be received from user devices having a small screen and the sorted list can be displayed on a large screen viewable by the multiple users of the user devices.

### BACKGROUND

1. Field

The disclosure is related to the sharing and display of information on a large screen device among multiple users of small screen devices.

2. Description of the Related Technology

There exist a number of large screen devices that are designed to be viewed by multiple people at the same time, including large screen televisions and projection screens. Many of these devices are operable by a single user to convey information from the single user to multiple people. There is currently a need for systems which allow multiple users to share information on a single screen.

### SUMMARY OF THE INVENTION

The systems and methods of the development each have several aspects, no single one of which is solely responsible for its desirable attributes. Without limiting the scope of this disclosure as expressed by the claims which follow, its more prominent features will now be discussed briefly. After considering this discussion, and particularly after reading the section entitled “Detailed Description of Certain Inventive Embodiments” one will understand how the sample features of this development provide advantages that include allowing multiple users to share information on a single screen.

One aspect of the development is a method of displaying a list, the method comprising receiving a first list of items from a first user device, generating a sorted list based on at least the first list and a second list, and displaying the sorted list. In one embodiment, the second list is received from a second user device. In another embodiment, generating the sorted list comprises compiling at least the first list and a second list into a compiled list and sorting the compiled list into the sorted list.

Another aspect of the development is a system for displaying a list, the system comprising a receiver configured to receive a first list of items from a first user device, a processor configured to generate a sorted list based on at least the first list and a second list, and a screen configured to display the sorted list. In one embodiment, the screen is designed to be viewed by multiple people at the same time. In another embodiment, the screen is larger than the screen of the first user device.

Another aspect of the development is a system for displaying a list, the system comprising means for receiving a first list of items from a first user device, means for generating a sorted list based on at least the first list and a second list, and means for displaying the sorted list.

Yet another aspect of the development is a computer-readable storage medium having instructions encoded thereon which, when executed by one or more processors, performs a method of displaying a list, the instructions including instructions for receiving a first list of items from a first user device, instructions for generating a sorted list based on at least the first list and a second list, and instructions for displaying the sorted list.

### BRIEF DESCRIPTION OF THE DRAWINGS

FIG. 1 is an illustration of a system of interconnected devices.

FIG. 2 is a flowchart of a method of compiling and displaying a list.

FIG. 3 is a flowchart of a method of pruning and displaying a list.

FIG. 4 is a flowchart of a method of sorting a list.

FIG. 5 is an exemplary diagram of a displayed list of favorites.

FIG. 6A is an exemplary diagram of a displayed list of stock quotes.

FIG. 6B is an exemplary diagram of a list of stock quotes prior to being shared by a user.

FIG. 6C is an exemplary diagram of a list of stock quotes after being shared by a user.

### DETAILED DESCRIPTION OF THE PREFERRED EMBODIMENT

The following detailed description is directed to certain specific aspects of the development. However, the development can be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Similarly, methods disclosed herein may performed by one or more computer processors configured to execute instructions retrieved from a computer-readable storage medium. A computer-readable storage medium stores information, such as data or instructions, for some interval of time, such that the information can be read by a computer during that interval of time. Examples of computer-readable storage media are memory, such as random access memory (RAM), and storage, such as hard drives, optical discs, flash memory, floppy disks, magnetic tape, paper tape, punch cards, and Zip drives.

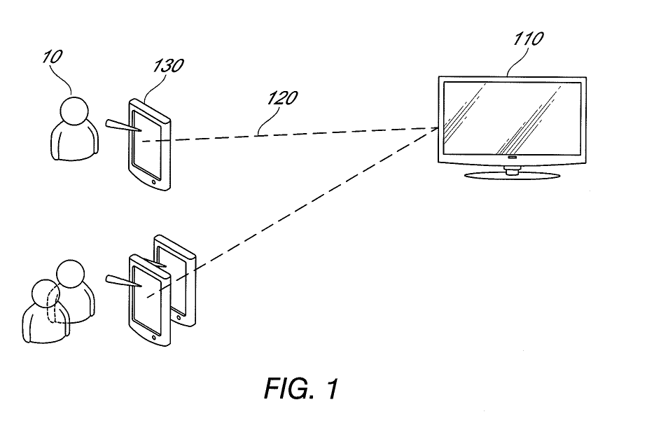

FIG. 1 is an illustration of a system of interconnected devices. The system 100 includes a first screen device 110, such as a personal computer attached to a large monitor, connected via a number of connection links 120 to a number of second screen devices 130, such as a laptop computer, a tablet PC, or a smartphone. The second screen devices 130 can each be used by a single user, or by multiple users sequentially. Users 10 of the second screen devices 130 can share lists of favorites over the connection links 120 for display by the first screen device 110.

The first screen device 110 can include a computer processor, memory and/or storage, one or more input devices, one or more output devices, and a network controller. The processor can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general purpose processor may be a microprocessor such as an ARM, Pentium®, Pentium II®, Pentium III®, Pentium IV®, Pentium® Pro, an 8051, a MIPS®, a Power PC®, an ALPHA®, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The processor can be coupled, via one or more buses, to read information from or write information to memory and/or storage. The processor may additionally, or in the alternative, contain memory, such as processor registers. The memory can include processor cache, including a multi-level hierarchical cache in which different levels have different capacities and access speeds. The memory can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The first screen device 110 can also include one or more input devices and one or more output devices for, respectively, receiving input from and providing output to, users 10 of the system 100. Suitable input devices include, but are not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays and printers, audio output devices, including speakers, headphones, earphones, and alarms, and haptic output devices, including force-feedback game controllers and vibrating devices.

In one embodiment, the first screen device 110 includes, or is operatively connected to, a large display screen designed to be viewed by more than one user simultaneously. For example, the size of the large display screen, measured diagonally as known to those skilled in the art, may be 34 inches or greater, 42 inches or greater, 50 inches or greater, 62 inches or greater, or 70 inches or greater. Various display technologies are useful for generating large images, including LCD display technology, plasma display technology, and projection display technology. The second screen devices 130 may also include a display which is smaller than the display screen of the first screen device 110. In particular, the large display screen may have at least twice the area of a screen on the second screen devices 130, at least three times the area of a screen on the second screen devices 130, at least five times the area of a screen on the second screen devices 130, or at least ten times the area of a screen on the second screen devices 130.

The first screen device 110 can also receive and transmit information over the various communication links 120 via a network controller, or network card. The network card can be an Ethernet card with a unique 48-bit serial number called a MAC address stored in ROM (read-only memory) carried on the card. The network card can be an expansion card which plugs into a network bus or it can be a network interface built into a motherboard of the system unit. The communication links 120 can be either wired or wireless links. Examples of wired links include wires and optical fibres. The communications links 120 can be established using a USB protocol or a FireWire protocol. Examples of wireless links include electromagnetic waves, such as radio waves or infrared waves, and acoustic waves. The communication links 120 can be established using an Ethernet protocol, a Wi-Fi protocol, or a Bluetooth protocol. Both Wi-Fi and Bluetooth technologies operate at least in the 2.4 GHz ISM frequency band. In order to establish a wireless electromagnetic link, the first screen device 110 or second screen devices 130 may employ one or more antennas. In order to establish a wireless acoustic link, the first screen device 110 or second screen devices 130 may employ a speaker and a microphone. The communication links 120 allow for two-way communication between the first screen device 110 and second screen devices 130. In another embodiment, the communication links 120 are one-way communication links from the second screen devices 130 to the first screen device 110.

As disclosed above, the first screen device 110 of the system 100 is connected, via a number of communication links 120, to a number of second screen devices 130. Alternatively, the first screen device 110 and the second screen devices 130 can be interconnected via a public access network, such as the Internet, or a private network. The network can communicate using a number of protocols known to those skilled in the art, including IPv4 or IPv6.

The second screen devices 130, like the first screen device 110, can include a processor, memory and/or storage, input and output devices, and a network interface. Embodiments of the various components are described in detail above. The second screen devices 130 can include consumer electronic devices, such as a cell phone or smart phone, a personal digital assistant (PDA), a portable music player, a tablet PC, or a laptop computer.

The second screen devices 130 can be configured to create and manage a list of favorites. Although the term, “favorite” often connotes a ranking of desirability or preference, the term has taken, at least, the additional meaning of internet bookmark due to its use in this way by popular web browsers. As used herein, a favorite is a data item, or representation thereof, indicated by a user as being a favorite. Thus, a list of favorites is a list of data items compiled, at least in part, by a user. A list of favorites can include, without limitation, a list of television channels, a list of television programs, a list of stocks, a list of internet videos, a list of web pages or websites, a list of songs, a list of photographs or image files, a list of widgets, or a list of apps or applications. The lists can be stored in the memory or storage of the second screen devices 130.

As discussed above, users 10 of the second screen devices 130 can share lists of favorites over the connection links 120 for display by the first screen device 110. In practice, the various lists received from the second screen devices 130 are compiled in a manner explained below to produce a composite or combined list for display to the users.

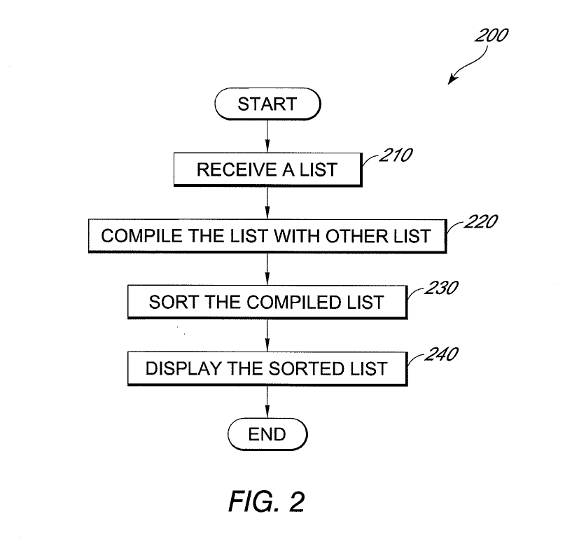

FIG. 2 is a flowchart illustrating a method of compiling and displaying lists, such as the lists received from the users of the second screen devices 130. The process 200 begins, in block 210, with the reception of a list. The list can be received by the first screen device 110 from a second screen device 130 over the communication link 120 of FIG. 1. The received list can also include an indication of intent to share the list. The indication of intent to share can be a command received over the communication link 120 or a “share flag” set in the transmitted data. The intent to share the list can also be inferred from the reception of the list. The intent to share the list can also be received separately from the list, such as at a later time.

The received list can also include a user code identifying the user sharing the list. The user code can also be generated by the first screen device 110 upon receiving the list. For example, the user code can be based on the MAC address or IP address of the second screen device 130. The user code can be generated sequentially as lists are received. The received list may also include a submission time and/or a share time indicating, respectively, when the list was submitted and when the user indicated intent to share the list. Similar data fields can additionally or alternatively be generated by the first screen device 110 to include a reception time and/or a share time indicating, respectively, when the list was received and when the indication of intent to share was received.

Next, in block 220, the received list is combined with other lists. In one embodiment, a shared list is stored as an array type data structure stored at the first screen device 110 of FIG. 1. In computer science terminology, an array is a data structure consisting of a group of items that are accessible by indexing. The array can occupy a contiguous area of storage. The shared list can be created and managed using object-oriented programming methods in which the array is specified in terms of a constructor and a number of operations including: a constructor for creating an empty array, an operation for adding (prepending or appending) items to the array, an operation for editing items of the array, an operation for removing items from the array, and an operation for sorting the array. Each item in the array may be associated with an index and include a number of fields. The fields can include a fundamental field, such as channel number, stock symbol, URL, etc., a user code field indicating which user (or users) shared the item, and a time indicating when the item was shared. In another embodiment, the user code field, or a separate field, indicates the number of users which have shared the item. The time indicating when the item was shared can be based on the earliest or latest time in which a user indicated intent to share the item or the earliest or latest time in which an indication of intent to share the item was received.

Upon receiving a list and an indication of intent to share the list, the first screen device 110 adds to the shared list any items of the received list which are not already present in the shared list. This addition can also include generating data for the user code field and time field as described above. For any items of the received list which are already present in the shared list, the first screen device 110 edits the items in the shared list to indicate that an additional user has expressed intent to share those items. This editing can include altering the user code field by adding an additional user code, or adding one to the number of users which have shared the item. The editing may also include altering the time field, particularly if it is based on the latest time in which a user indicated intent to share the item or when the indication of intent to share the item was received.

As mentioned above, the first screen device 110 can receive the list separately from the indication of intent to share. In one embodiment, the first screen device 110 stores the received list separately until the indication of intent to share is received, at which point it combines the list with the shared list as disclosed above. In another embodiment, the first screen device 110 stores a master list as an array type data structure. Each item in the master list may be associated with an index and include a number of fields. The fields can include a fundamental field, such as channel number, stock symbol, URL, etc., a user code submission field indicating which user (or users) submitted the item, a user code share field indicating which users submitted an indication of intent to share the item, a submit time indicating when the item was submitted or received, and share time indicating when the indication of intent to share was submitted or received. The times can be based on the earliest or latest time in which a user submitted the item or intent to share or the earliest or latest time in which the item or intent to share was received. When an indication of intent to share is received from a particular user, the first screen device 110 can edit the user code share field of items of the master list which have a user code submission field indicating that they were submitted by the particular user to indicate that an indication of intent to share has been submitted by the particular user.

A shared list can be created from the master list at any time be generating a list having only the items with a user code in the user code share field.

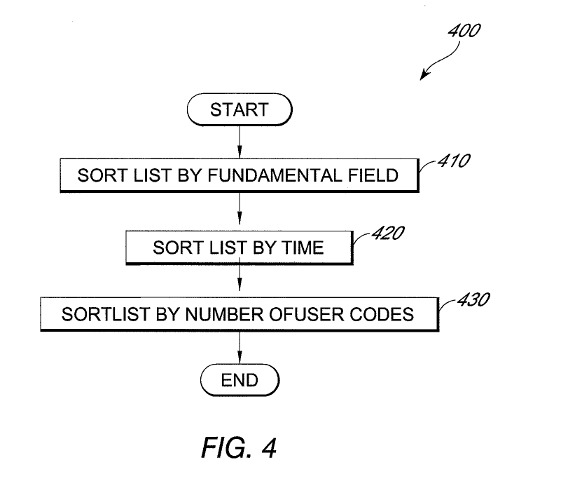

The process 200 continues, in block 230, with a sort of the compiled list. In one embodiment, the first screen device 110 sorts the shared list to generate a sorted list. Although a different term is used (i.e. “sorted list” and “shared list”), it will be appreciated by those of ordinary skill in the art that the sorted list and shared list can be the same data structure, with the different terminology expressing the results after different operations of the process 200. However, in one embodiment, the sorted list and shared list are different data structures which are stored separately. The shared list can be sorted by any of a number of sorting methods known to those skilled in the art according to any of number of criteria. In particular, sorting algorithms which may be employed by a processor of the first device include, but are not limited to, bubble sort, comb sort, gnome sort, selection sort, insertion sort, and merge sort. A particular non-limiting sorting methodology is described below with respect to FIG. 4.

The process 200 finishes, in block 240, with the display of the sorted list. The display can be performed by the first screen device 110 via a large display screen. In another embodiment, the display is performed by the first screen device 110 transmitting display data to the second screen devices 130 for display on the second screen devices 130. The display of the list can also include the display of data related to items of the list. For example, if the list is a list of stock symbols, the display may also include the display of stock quotes associated with the stock symbols. If the list is a list of television broadcast channels, the display may also include an indication of an event currently being broadcast on the channel. The display may additionally or alternatively include an option for interacting with the items of the list. For example, if the list is a list of stock quotes, there may be displayed an option for updating the displayed stock quotes. If the list is a list of television broadcast channels, the display there may be displayed an option to display the event being broadcast on the channel. If the list is a list of URLs, there may be displayed an option to being web browsing at that URL. If the list is a list of videos, there may be displayed an option to view the video.

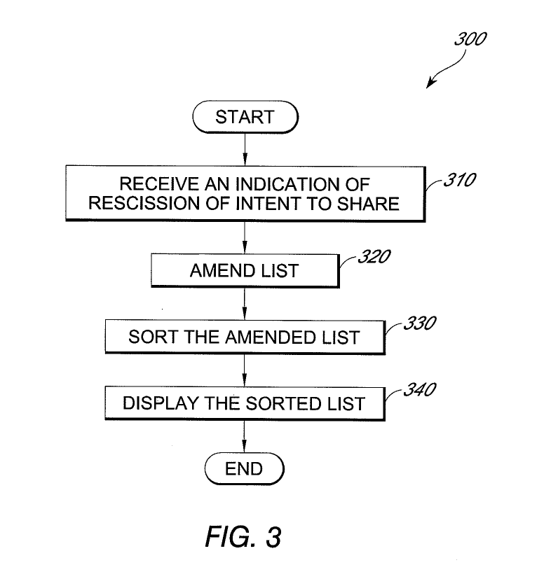

As mentioned above, the list and indication of intent to share can be submitted or received separately. An indication of a rescission of intent to share can also be submitted or received. This allows users to alternatively share and cease sharing a list of favorites. FIG. 3 is a flowchart of a method of pruning and displaying a list.

The process 300 begins, in block 310, with the reception of an indication of rescission of intent to share a list. In one embodiment, the first screen device 110 receives the indication from a second screen device 130. A user code can also be received with the indication or generated by the first screen device 110 as described above.

Next, in block 320, a list is amended. In one embodiment, the first screen device 110 amends a shared list as described above. The amendment can include removing the user code received or generated in block 310 from the user code field having the user code in the user code field. Amending the shared list can also include removing items for which there are no user codes in the user code field.

In another embodiment, the first screen device 110 amends a master list as described above. The amendment can include removing the user code received or generated in block 310 from the user code share field of items having the user code in the user code share field. In this embodiment, amending the master list need not include removing items for which there are not user codes in the user code share field, as the shared list is generated only from items for which there is a user code in the user code share field. This separation of submission and intent to share allows the user to resubmit an indication of intent to share without having to resubmit the user's list. After receiving an indication of intent to share, the master list is amended as described in FIG. 2 and the shared list is recreated.

The process 300 continues, in block 330, with a sort of the amended list. As described above with respect to FIG. 2, in one embodiment, the first screen device 110 sorts the shared list to generate a sorted list. Although a different term is used (i.e. “sorted list” and “shared list”), it will be appreciated by those of ordinary skill in the art that the sorted list and shared list can be the same data structure, with the different terminology expressing the results after different operations of the process 300. However, in one embodiment, the sorted list and shared list are different data structures which are stored separately. The shared list can be sorted by any of a number of ways according to any of number of criteria. A particular non-limiting sorting methodology is described below with respect to FIG. 4.

The process 300 finishes, in block 340, with the display of the sorted list. As described above with respect to FIG. 2, the display can be performed by the first screen device 110 via a large display screen. In another embodiment, the display is performed by the first screen device 110 transmitting display data to the second screen devices 130 for display on the second screen devices 130. The display of the list can also include the display of data related to items of the list. The display may additionally or alternatively include an option for interacting with the items of the list. Examples of both are discussed above with respect to block 240 of FIG. 2.

A sort is performed in block 230 of FIG. 2 and block 330 of FIG. 3. FIG. 4 is a flowchart of a method of sorting a list. The method 400 takes a combined list and sorts the items of the list so that the items shared by multiple users “float to the top,” with the items further sorted by a time, and sorted further still by a fundamental field. The method 400 relies upon any simple stable numeric and lexicographic sorting algorithm such as one provided by the language, platform, or standard libraries. A stable sorting algorithm, as used herein, is any sorting algorithm which preserves the original order of items with equivalent sort keys.

The method 400 begins, at block 410, by sorting the list by a fundamental field. As described above with respect to FIG. 2, the list can be stored as an array data structure, with each item being associated with an index and a number of fields. The fields can include a fundamental field, such as channel number, stock symbol, URL, or other basic property of the elements of the list. The list is first sorted by this field. For example, if the field is a string, such as a stock symbol, the items can be sorted alphabetically. If the field is a number, such as a channel number, the items can be sorted numerically. The sorting algorithm can reassign indices to each of the items of the array.

Next, in block 410, the list is sorted by time. As described above with respect to FIG. 2, the time field can store a submit time indicating when the item was submitted or received and/or a share time indicating when the indication of intent to share was submitted or received. The times can be based on the earliest or latest time in which a user submitted the item or intent to share or the earliest or latest time in which the item or intent to share was received. The time field may be rounded to the nearest hour, half-hour, ten minute interval, five minute interval, minute, second, or not at all. The sort by time can be done such that later submitted/shared items are sorted above earlier submitted/shared items. The sort by time can alternatively be done such that earlier submitted/shared items are sorted above later submitted/shared items. As the stable sorting algorithm preserves the original order of items with equivalent sort keys, items submitted/shared at the same time remain sorted by the fundamental field.

The process 400 finishes in block 430 in which the list is sorted by the number of user codes in the user code field or user code share field. As the stable sorting algorithm preserves the original order of items with equivalent sort keys, items with the same number of user codes remain sorted by time and fundamental field.

The process 400 generally sorts the items by relevancy, where those items shared by the most people are at the top of the list, and items are sorted by timeliness, and underlying fundamental field. Additional or different sort criteria could be used without departing from the scope of this disclosure, including the performance of a sort by the submission time rather than sort by a share time described with respect to block 420, the performance a sort by the number of users who submitted a favorite in between the sorts described with respect to blocks 420 and 430, or the performance of an additional sort by the extra information displayed. For example, if the items are stock symbols, the items may be sorted, after performing the sort described with respect to block 430, by an updated stock quote or a percentage change in stock price over a particular period.

Sorting can also be based on a profile or account associated with the user of the user device or information stored in the profile. For example, the profile can store a name associated with the user, an age associated with the user, or a role associated with the user. Sorting may be such that the favorites are listed alphabetically by name, or numerically by age. A role or type associated with the user may be selected by the user and include a ranking. For example parents and children may have different roles stored in the profile. The role may be selected from group including moderator, player, and observer.

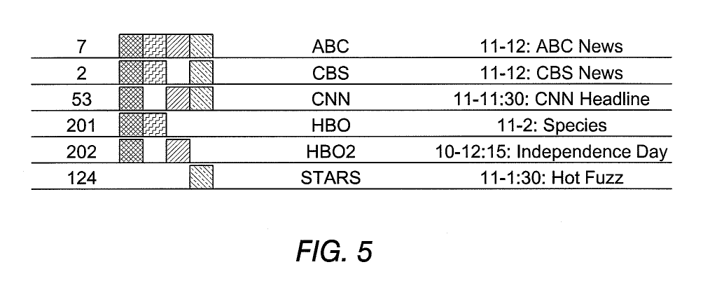

FIG. 5 is an exemplary diagram of a displayed list of channels. This example is merely presented to illustrate potential results of the sorting method 400 described in FIG. 4 and is in no way limiting as to the sort of the method 400. In the example of FIG. 5, there are four users that are currently sharing their favorites (and an unknown number that are not). Each user is coded with a color which is displayed with the list. Neither the sorting method 400, nor any other part of the present disclosure is limited to channels, four users, or users associated with colors.

In the example of FIG. 5, the fundamental field is taken to be a channel number. Thus, channel 201 appears before channel 202 as both have two users sharing them and 201 is the lower channel. Similarly, channel 2 precedes channel 52, as both have three users sharing them. Note that channel 2 appears below channel 7 as channel 7 has four users sharing that channel as compared to the three users sharing channel 2.

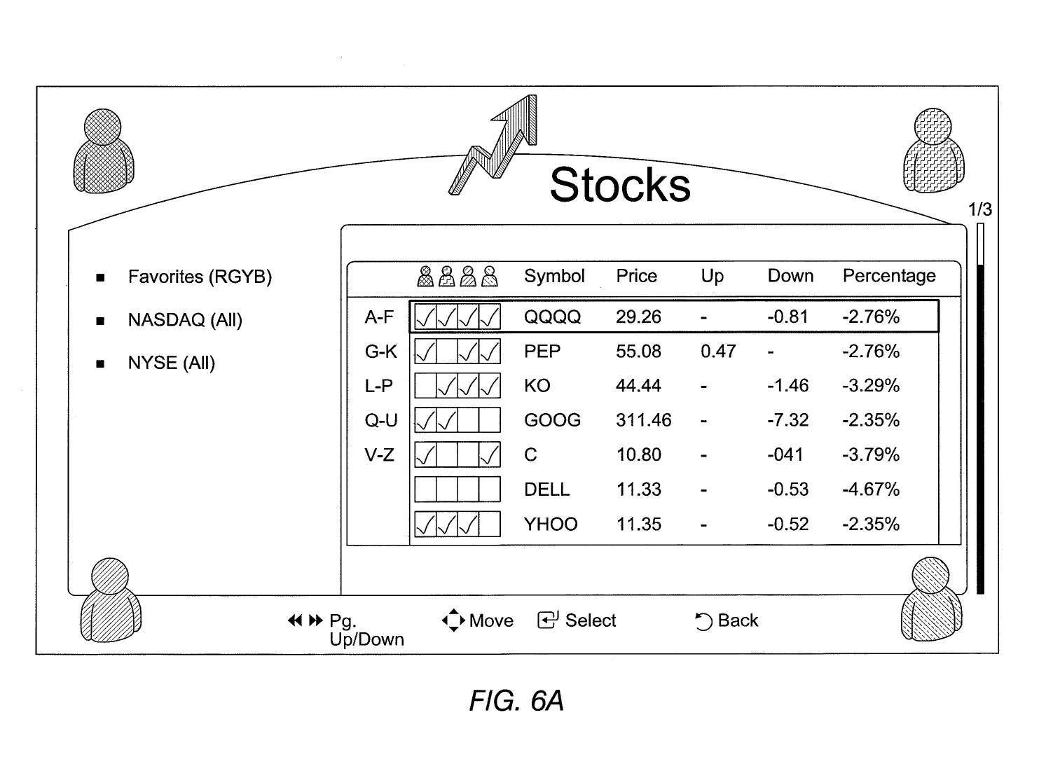

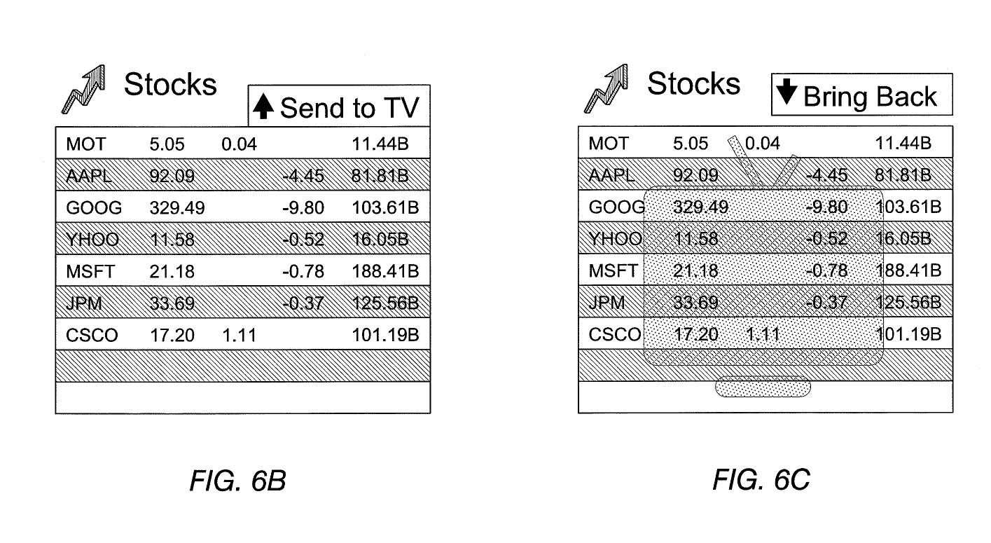

FIG. 6A is an exemplary diagram of a displayed list of stock quotes. As above, this example is merely presented to illustrate potential results and is no way limiting as to the sorting methodology. The screen of FIG. 6A may be displayed, for example, on a shared viewing screen by various users. In the example of FIG. 6A, stocks are displayed as well as the users who have chosen to share the stocks. Additional information, including price and percentage change is also displayed next to the stock quotes.

FIG. 6B is an exemplary diagram of a list of stock quotes as they appear prior to being shared by the user. The screen of FIG. 6B may be displayed, for example, on a personal device such as a cell phone, a PDA, a laptop computer, or a netbook computer. In the example of FIG. 6B, selected stocks are displayed with an option to share the list of selected stocks.

FIG. 6C is an exemplary diagram of a list of stock quotes as they appear after being shared by the user. The screen of FIG. 6C may be displayed, for example, on a personal device such as those described above with respect to FIG. 6B. In the example of FIG. 6C, the list of shared stocks is partially displayed with an option to rescind the list.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

In particular, processes 200 and 300 are described as being performable by the first screen device 110 of FIG. 1. It is to be understood that other devices could perform the processes 200, 300 or portions thereof, including the second screen devices 130 of FIG. 1 or an application server operatively connected to the first screen device 110, communication links 120, or the second screen devices 130.

What is claimed is:

1. A method of displaying a list, the method comprising:
receiving a first list of items from a first user device;
generating, using a processor, a sorted list based on at least the first list and a second list stored in a memory; and
displaying the sorted list on a shared viewing device.

2. The method of claim 1, further comprising receiving the second list from a second user device and storing the second list in the memory.

3. The method of claim 1, wherein receiving a first list comprises receiving a first list via a wireless link.

4. The method of claim 1, wherein the first list comprises a list of stocks, a list of television channels, a list of television programs, a list of websites or bookmarks, a list of videos, a list of songs, a list of photographs or image files, a list of widgets, or a list of apps or applications.

5. The method of claim 1, further comprising receiving an indication of intent to share the first list.

6. The method of claim 5, wherein the receiving an indication of intent to share is received separately from the first list.

7. The method of claim 1, wherein the first list is associated with a user code.

8. The method of claim 1, wherein generating the sorted list comprises:
compiling at least the first list and a second list into a compiled list; and
sorting the compiled list into the sorted list.

9. The method of claim 8, wherein sorting the compiled list comprises:
sorting the compiled list by a fundamental field into a first intermediate list;
sorting the first intermediate list by a time into a second intermediate list; and
sorting the second intermediate list by a number of user codes into the sorted list.

10. The method of claim 9, wherein the time is indicative of a time when an item of the first intermediate list was transmitted, a time when an item of the first intermediate list was received, or a time when an item of the first intermediate list was shared.

11. The method of claim 8, wherein sorting the compiled list is based on at least one of a priority or a profile associated with the user device.

12. The method of claim 1, further comprising:
receiving, from a first user device, an indication of rescission of intent to share the first list;
removing, from the sorted list, items of the first list to generate an abridged list; and
sorting the abridged list into a re-sorted list; and
displaying the re-sorted list.

13. The method of claim 1, wherein the first user device comprises at least one of a cell phone, a personal digital assistant (PDA), a portable music player, a laptop computer, a netbook computer, or a tablet PC.

14. A system for displaying a list, the system comprising:
a receiver configured to receive a first list of items from a first user device;
a processor configured to generate a sorted list based on at least the first list and a second list; and
a screen configured to display the sorted list.

15. The system of claim 14, further comprising a storage in data communication with the processor configured to store at least one of the first list, the second list, and the sorted list.

16. The system of claim 15, wherein at least one of the first list, the second list, or the sorted list is stored as an array type data structure in which each element of the list is associated with an index and a plurality of fields.

17. The system of claim 16, wherein the plurality of fields comprises at least one of a fundamental field, a time, and a number of user codes.

18. The system of claim 14, wherein the screen is designed to be viewed by multiple people at the same time.

19. The system of claim 18, wherein the screen employs LCD display, plasma display, or projection technology.

20. The system of claim 14, wherein the screen is larger than a screen of the first user device.

21. The system of claim 20, wherein the screen has at least three times the area of the first user device.

22. The system of claim 21, wherein the screen has at least five times the area of the first user device.

23. A system for displaying a list, the system comprising:
a communal device comprising:
a receiver configured to receive a plurality of personal lists from a respective plurality of personal user devices associated with a respective plurality of users;
a processor configured to generate a shared list based, at least in part on the plurality of personal lists; and
a screen configured to display the shared list to the plurality of users.

24. The system of claim 23, wherein the personal user devices comprise at least one of a cell phone, a personal digital assistant (PDA), a portable music player, a laptop computer, a netbook computer, or a tablet PC.

25. A system for displaying a list, the system comprising:
means for receiving a first list of items from a first user device;
means for generating a sorted list based on at least the first list and a second list; and
means for displaying the sorted list.

26. The system of claim 25, wherein the means for receiving comprises at least one of an antenna, a microphone, a network controller, and a network card; the means for generating comprises a processor; and the means for displaying comprises at least one of a processor, a video card, and a screen.

27. A computer-readable storage medium having instructions encoded thereon which, when executed by one or more processors, performs a method of displaying a list, the method comprising:
receiving a first list of items from a first user device;
generating a sorted list based on at least the first list and a second list; and
displaying the sorted list.
